(19) United States
(12) Patent Application Publication
(10) Pub. No.: US 2022/0219929 A1
(43) Pub. Date: Jul. 14, 2022

(54) Web Transport Control Device

(71) Applicant: BST GmbH, Bielefeld (DE)

(72) Inventors: Ulrich Prims, Bielefeld (DE); Robin Lorenz, Herford (DE); Jörgen Schumacher, Herford (DE)

(21) Appl. No.: 17/572,141

(22) Filed: Jan. 10, 2022

(30) Foreign Application Priority Data
Jan. 13, 2021 (EP) 21151278.5

(51) Int. Cl. B65H 23/038; B65H 23/035; B65H 23/032

(52) U.S. Cl. CPC B65H 23/038; B65H 23/0324; B65H 23/035

(57) ABSTRACT

A web transport control device having a plurality of rotary frame units each of which includes a carrier frame, a rotary frame parallel thereto and carrying an input roller and an output roller for a material web, and pivotably supported on the carrier frame, a web guiding system arranged such that each of the material webs is fed to one of the input rollers, deflected thereat and then deflected again at the output roller, wherein the rotary frame units are nested one in the other such that web sections of the webs that extend between respective input and output rollers are parallel to one another and the spacing between two neighboring web sections is not larger than the sum of diameters of the input and output rollers, and the input rollers are offset relative to one another in the direction parallel to the web sections.

The invention relates to a web transport control device having a plurality of rotary frame units each of which comprises a carrier frame and a rotary frame which is parallel to the carrier frame and carries an input roller and an output roller for a material web to be controlled and which is pivotably supported on the carrier frame by means of a bearing, the device further comprising a web guiding system arranged such that each of a plurality of material webs is fed to one of the input rollers, is deflected thereat and is then deflected again at the output roller.

When running material webs are to be processed, e.g. in the manufacture of composite webs for tire carcasses, it is frequently required to merge a plurality of material webs in correct lateral alignment. The movement of each web must be steered or feedback-controlled such that the web is prevented from migrating in the direction transverse to the running direction. To that end, the web is threaded through the rotary frame unit such that it is respectively deflected, by 90° for example, at the input roller and at the output roller. If the running direction deviates from the desired direction, the rotary frame which carries the input roller and the output roller is rotated relative to the carrier frame such that the input and output rollers take another posture and steer the web back into the desired direction.

In most conventional rotary frame constructions, the input roller and the output roller are mounted, with their axes in parallel, on a plane that is parallel with the rotary frame but is offset from the plane of the rotary frame such that the rollers can rotate freely. The rotary frame and the carrier frame are approximately congruent and are also arranged in planes that are offset from one another, so that they can be pivoted relative to one another. Thus, as a whole, the rotary frame construction has a three-layer design. An example of such an arrangement is shown in US 2003/213867 A1.

The rotation center about which the rotary frame is pivoted relative to the carrier frame should ideally be positioned in the center of the incoming web, so that the pivotal axis is orthogonal to the plane of the rotary frame and extends tangentially with respect to the outer vertex of the input roller. In this way, it can be achieved that, when the rotary frame is pivoted, the incoming web remains practically stationary whereas the outgoing web is displaced in the desired direction.

A bearing with a virtual rotation center has the advantage that the ideal position for the pivotal axis can be realized without any mechanical axis or bearing elements that could collide with the incoming web being present in this position. The bearing construction must be stable enough to withstand the force that is caused by the tension of the web and has the tendency to drag the rotary frame away from the carrier frame.

DE 20 2017 100 819 U1 discloses a rotary frame construction that is outstanding in having a particularly small constructional height.

It is an object of the invention to provide a web transport control device with reduced space requirement.

According to the invention, in order to achieve this object, the rotary frame units are nested one in the other such that web sections of the plurality of webs that extend between the respective input and out rollers are parallel to one another and the spacing between two neighboring ones of these web sections is not larger than the sum of the diameters of the input and output rollers between which these web sections extend, and the input rollers of the plurality of rotary frame units are offset relative to one another in the direction parallel to the web sections.

Thanks to the nested arrangement of the rotary frame units and to the small spacings between these units in the direction normal to the planes of the frames, a very compact design of the entire web transport control system can be achieved. This leads not only to a reduction of the required installation space but also to a shortening of the path of travel of the webs, which makes it possible to achieve a more stable web transport and a simplified design of the web guide system. Thanks to the offset of the input rollers, the possibility to deflect the webs at these input rollers by 90°, respectively, is preserved. If the virtual rotation center of the rotary frame is located at the outer vertex of the input roller, then the pivotal axis of the rotary frame coincides with the center of the incoming web portion, so that, when the rotary frame is pivoted, this incoming web portion will only be subject to a torsion, whereas the web tension will remain essentially uniform over the entire width of the web.

Useful embodiments of the invention are indicated in the dependent claims.

If the input and output rollers of all rotary frame units have the same diameter, then the spacing between the parallel web sections is smaller than twice this diameter. In case of a Z-thread, the rotary frame units have, in a side view, an approximately L-shaped overall configuration, and the length of the shorter leg of the L corresponds to twice the diameter of the rollers. Then, the rotary frame units are nested in such a manner that they overlap also in the direction normal to the planes of the frames.

In one embodiment, all rotary frame units have the same dimensions. This enables not only an efficient production but has also the advantage that the output rollers are also offset from one another in the running direction of the web sections, so that a 90° deflection of the web portions may also take place at the output rollers.

In another embodiment, the web guide system is configured for a U-thread. In this case, the spacings between the input roller and the output roller are different for the different rotary frame units, and the U-shaped web paths are nested one in the other.

Embodiment examples will now be described in conjunction with the drawings, wherein:

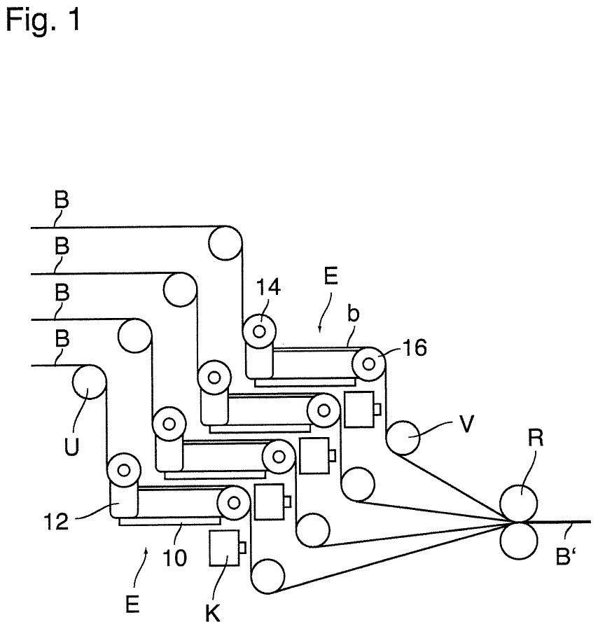

FIG. 1 is a schematic view of a web transport control device according to a first embodiment;

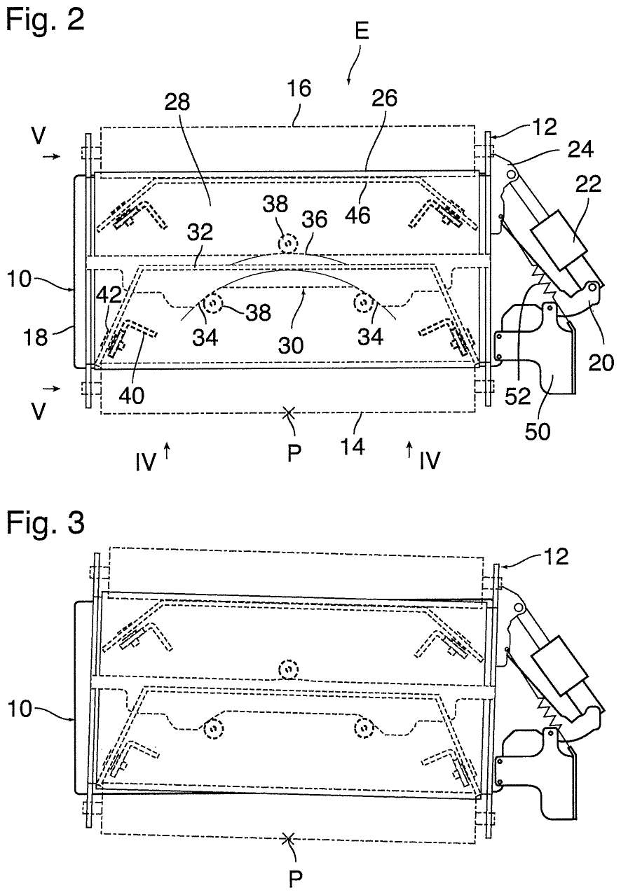

FIG. 2 is a schematic top plan view of a rotary frame construction;

FIG. 3 shows the rotary frame construction with a slightly pivoted rotary frame;

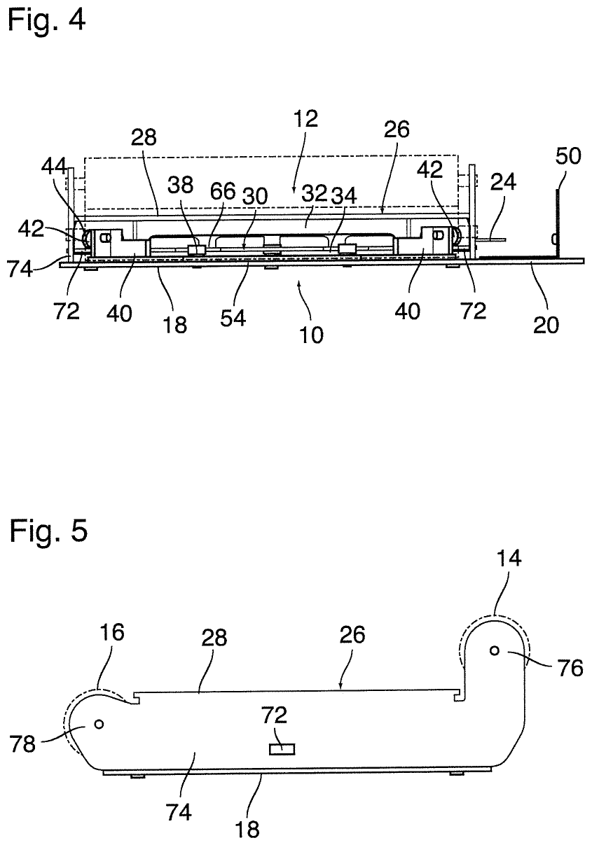

FIG. 4 is a view of the rotary frame construction as seen in the direction of arrows IV-IV in FIG. 2;

FIG. 5 is an enlarged side view of the rotary frame construction as seen in the direction of arrows V-V in FIG. 2; and

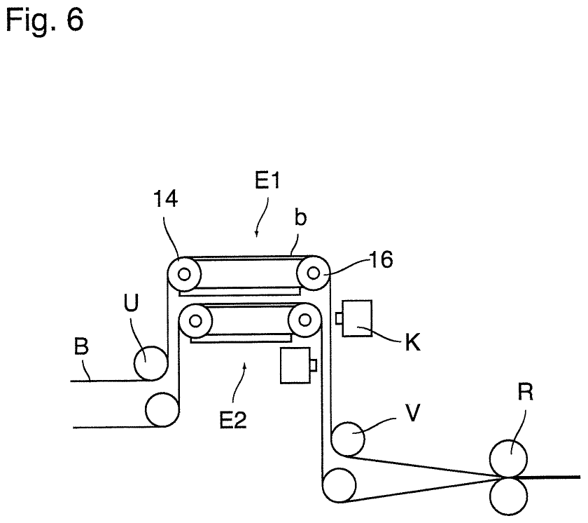

FIG. 6 shows a web transport control device according to another embodiment.

FIG. 1 schematically shows the design of a web transport control device according to the invention having four rotary frame units E. All four rotary frame units have equal dimensions and an L-shaped overall configuration and are thereby designed for a Z-thread of four material webs B. Each rotary frame unit E has a stationary carrier frame 10 and a rotary frame 12 that is pivotable relative to the carrier frame. An input roller 14 and an output roller 16 are rotatably supported in each rotary frame 12. A web guide system is formed by two sets of deflection rollers U, V over which the webs B are trained such that they are deflected by 90° at the input roller 14, from the vertical direction into the horizontal direction in this example, and that they are deflected again by 90° at the output roller 16. From the downstream deflection rollers V, the webs then converge to a roller pair R in the nip of which the webs are merged and laminated one upon the other so that, together, they form a composite web B′.

In the vertical portion between the output roller 16 and the downstream deflection roller V, the lateral position of each web is detected by means of a camera K. On the basis of these position data, the rotary movements of the rotary frames 12 are controlled such that the lateral position of each web is adjusted to a respective target value, so that the webs are laminated with the correct position register.

The planes of the carrier frames 10 of all four rotary frame units E are parallel to one another. Between the input roller 14 and the output roller 16, each web B forms a web section b that is parallel with the plane of the frame. Thus, all four web sections b are parallel to one another.

In the example shown, the input rollers 14 and output rollers 16 of all four rotary frame units have an equal diameter. In this example, the spacing between two neighboring web sections b, measured in the direction normal to the plane of the frame, is only 1.5 times the diameter of the input and output rollers, so that the input roller 14 of each rotary frame unit (except the topmost one) overlaps in height with the output roller 16 of the next higher rotary frame unit. In this way, the L-shaped rotary frame units E are compactly nested one in the other.

An example for a possible design of an individual rotary frame unit E will now be explained in conjunction with FIGS. 2 to 5.

FIG. 2 shows a top plan view of one of the rotary frame units E. What can be seen here are the carrier frame 10 and the rotary frame 12 that is pivotable relative to the carrier frame about a virtual rotation center P. FIG. 3 shows the rotary frame construction with the rotary frame slightly pivoted. For ease of distinction, all parts that belong to the (stationary) carrier frame 10 have been shown in bolder lines than the parts that are movable with the rotary frame 12.

The input roller 14 and the output roller 16 are rotatably supported in the rotary frame 12, and a material web which has not been shown and the movement of which shall be steered by means of the rotary frame construction is threaded over the input and output rollers. For example, in a Z-thread as in FIG. 1, the material web may, run downwards (in the direction away from the viewer in FIG. 1) to the input roller 14 where it is deflected into the horizontal direction so as to be passed-on to the output roller 16 where it is deflected again so that it will then move downwards again.

The carrier frame 10 has a horizontal base plate 18 the greatest part of which is hidden by the rotary frame 12 in FIG. 2, so that only the left edge of the base plate 18 is visible. On the right side in FIG. 2, the base plate 18 forms a lever 20 that projects beyond the lateral edge of the rotary frame 12 and is connected to a bracket or a lever 24 of the rotary frame via an articulated linear drive 22. When the linear drive 22 draws the levers 20 and 24 together, the rotary frame 20 pivots about the vertical pivotal axis that passes through the rotation center P, as has been shown in FIG. 3. This pivotal axis forms a tangent to the input roller 14, so that the input roller and, therewith, the incoming material web does not make any lateral movement when the rotary frame 12 is rotated, whereas the output roller 16 and the outgoing material web are displaced in lateral direction.

The rotary frame 12 forms a gutter-shaped downwardly open casing 26 the top wall of which forms a cross-bar 28 for holding a cam plate 30 that is accommodated in the interior of the casing 26 and is connected to the cross-bar 28 by a wall member 32 that is trapezoidal in plan view.

The edge of the cam plate 30 forms, on the bottom side in FIG. 2, two control curves 34 shaped as circular arcs and, on the top side, another control curve 36 shaped as a circular arc. The control curves 34 and 36 are centered on the virtual rotation center P. In order to illustrate the curvature of the control curves 34, 36 more clearly, FIG. 2 shows extended circular arc segments (continuous lines). Associated with each of the control curves 34, 36 is a follower roll 38 that is supported on the carrier frame 10 so as to be rotatable about a vertical axis. The three follower rolls 38 engage the edge of the cam plate 30 practically without play, so that this cam plate and, therewith, the entire rotary frame 12 can only perform a circular movement relative to the carrier frame about the virtual rotation center P.

Four brackets 40 that project vertically from the base plate and each support a support roller 42 have been welded onto the carrier frame 10. Two of these support rollers 42 are accommodated in slots 44 (FIG. 4) that extend horizontally in the legs of the trapezoidal wall member 32. These legs of the wall member 32 are angled such that they extend tangentially to an arc of a circle around the virtual rotation center P. If a downwardly directed force (weight) acts upon the rotary frame 12, then the top edges of the slots 44 are urged against the support rollers 42 so that the wall member 32 and, therewith, the entire rotary frame 12 are supported on the support rollers 42. When the rotary frame is pivoted, there is a relative movement between the support roller and the slot, and the support roller rolls along the top edge of the slot.

In the case that the rotary frame 20 is subject to an upwardly directed force, the lower edges of the slots 44 are urged against the support rollers 42, and in case of a pivotal movement, the support rollers will roll along these lower edges of the slots. The play of the support rollers 42 in the slots 44 is on the one hand so large that the support rollers can move with low friction and is on the other hand so small that the vertical movement of the wall member 32 relative to the support frame, as admitted by the play, remains within the admissible tolerances.

The casing 26 of the rotary frame 12 accommodates another wall member 46 that is trapezoidal in plan view and is fixed on the bottom side of the cross-bar 28, and slots are formed in the angled legs of this wall member. Two of the four support rollers 42 are accommodated in these slots of the wall member 46. The legs of this wall member are also angled such that they extend tangentially to an arc of a circle around the virtual rotation center P. The wall member 46 is therefore guided and supported with low play by the support rollers 42 in the same manner as the wall member 32. All in all, the engagement of the support rollers 42 in the slots 44, 48 prevents a vertical movement of the rotary frame relative to the carrier frame, and the rotary frame and the carrier frame are held in exact parallel alignment.

A holder 50 for one end of a tension spring 52 is mounted on the base plate 18 of the carrier frame and on the lever 20 formed by this base plate. The other end of the tension spring is anchored at the lever 24 of the rotary frame 12, so that a permanent tensioning force is produced that has the tendency to draw the levers 20 and 24 together and to rotate the rotary frame 12 counter-clockwise relative to the carrier frame 10. However, the linear drive 22 is self-arresting at least in the direction in which its length decreases, so that the torque exerted by the tension spring 52 does not actually cause a rotation of the rotary frame 12. However, the elastic bias that is cause by the spring 52 has the effect that any play in the bearing formed by the control curves 34, 36 and the follower rolls 38 as well as any play in the linear drive 22 and its articulated joints with the levers 20, 24 is eliminated.

When the web transport control device is operating, the lateral position of the material web is detected by means of a sensor, and the linear drive 22 is controlled by means of a controller such that the position of the material web is adjusted to a target value. In this feedback-control process, the linear drive 22 is alternatingly extended and retracted in order to rotate the rotary frame in the one direction or the other. The tension spring 52 assures that no hysteresis occurs in this control process because the spring will always hold all components of the system in which a certain play may occur at the same limit of the range of movement that is admitted by the play.

FIG. 4 shows the rotary frame construction in a front view. Welded on the base plate 18 of the carrier frame 10 is a support plate 54 on which the follower rolls 34 are rotatably supported.

The brackets 40 for the support rollers 42 are also welded to the support plate 54. In order to assure an exact positioning and safe immobilization of the brackets 40, these brackets are formed, on the edge facing the support plate 54, with pegs which have not been shown and which engage in corresponding peg holes of the support plate 54.

In FIG. 4, the wall member 46 is largely obscured by the wall member 32 that is disposed in front thereof, so that what is visible are only downwardly projecting studs 66. These studs are formed at their bottom ends with pegs 68 for engagement in peg holes 70 of the cam plate 30. The cam plate 30 is welded to the pegs 68 and is thereby immobilized in its position in the rotary frame 12. For further stabilization, the cam plate 30 has projections 72 at both ends, these projections being in form-fitting engagement with corresponding recesses in side walls 74 of the casing 26.

FIG. 5 shows the rotary frame construction in a side view. Of the carrier frame, only the base plate 18 is visible here. The side walls 74 of the casing 26 of the rotary frame are prolonged at both ends to form bearing brackets 76 for the input roller 14 and the output roller 16. These bearing brackets may have different shapes, depending upon the desired type of threading of the material web. FIG. 5 shows the configuration for Z-thread.

Without the bearing brackets 76 and the input roller 14, the entire constructional height of the rotary frame construction is only slightly larger than the diameter of the input and output rollers 14, 16. Moreover, FIG. 5 shows one of the projections 72 of the cam plate that penetrate the side wall 74.

FIG. 6 illustrates another possible embodiment of a web transport control device, having two rotary frame units E1 and E2 that are configured for a nested U-thread. The horizontal web sections b between the input roller and the output roller extend in parallel and have the same spacing as in FIG. 1. The input rollers of the two rotary frame units are offset in the running direction of the web sections b so far that the incoming web portions that are deflected at the deflection rollers U can both extend in vertical direction and in parallel with one another.

In the example shown, the output rollers 16 are also offset from one another so that the outgoing web portions that pass-on to the deflection rollers V may also extend in vertical direction and in parallel with one another. Since only two webs B are present in this example, the cameras K for position detection can be arranged on opposite sides of the webs, so that the spacing between the outgoing web portions may be kept very small.

In another embodiment, the output rollers 16 may be arranged vertically one above the other, and the deflection rollers V may be arranged such that the outgoing web portions are slightly tilted relative to the vertical and therefore lie in different planes.

What is claimed is:

1. A web transport control device comprising:
a plurality of rotary frame units each of which comprises:
a carrier frame and
a rotary frame which is parallel to the carrier frame and carries an input roller and an output roller for a material web to be controlled, and which is pivotably supported on the carrier frame by a bearing, and
a web guiding system arranged such that each of a plurality of material webs is fed to one of the input rollers, is deflected thereat and is then deflected again at the output roller,
wherein the rotary frame units are nested one in the other such that web sections the plurality of webs that extend between the respective input and out rollers are parallel to one another and the spacing between two neighboring ones of these web sections is not larger than the sum of the diameters of the input and output rollers between which these web sections extend, and
wherein the input rollers of the plurality of rotary frame units are offset relative to one another in the direction parallel to the web sections.

2. The web transport control device according to claim 1, wherein the webs are deflected by 90° at the input rollers.

3. The web transport control device according to claim 1, wherein the rotary frame units and the web guiding system are configured for a Z-thread.

4. The web transport control device according to claim 3, wherein the rotary frame units have equal dimensions.

5. The web transport control device according to claim 1, wherein the rotary frame units and the web guiding system are configured for a U-thread, the U-threads are nested, and the spacings between the input rollers and the output rollers of the rotary frame units increase outwardly.

6. The web transport control device according to claim 1, wherein the input rollers and the output rollers of all rotary frame units have equal diameters.

7. The web transport control device according to claim 1, wherein the webs are deflected by 90° at the respective output rollers.
